(19) United States
(12) Patent Application Publication
(10) Pub. No.: US 2019/0068599 A1
(43) Pub. Date: Feb. 28, 2019

(54) Multi-Factor Privilege Granting

(71) Applicant: Microsoft Technology Licensing, LLC, Redmond, WA (US)

(72) Inventors: Kenneth Mitchell Jakubzak, Lynnwood, WA (US); Fahrim Ur Rahman, Redmond, WA (US)

(73) Assignee: Microsoft Technology Licensing, LLC, Redmond, WA (US)

(21) Appl. No.: 15/691,854

(22) Filed: Aug. 31, 2017

(51) Int. Cl. H04L 29/06

(52) U.S. Cl. CPC H04L 63/10; H04L 63/0861

(57) ABSTRACT

Described herein are techniques for granting a privilege. A granting user is identified using facial recognition. The identity of the granting user is confirmed using voice recognition and privilege(s) to be granted by the granting user are determined. Using a device associated with the identified granting user, receipt of a code is confirmed. Optionally, confirmation that the code was audibly read by the granting user is performed using voice recognition. Once the granting user's identity has been confirmed using facial recognition and voice recognition, privilege(s) are granted to the other user(s).

### BACKGROUND

Modern computer users have access to a variety of computing resources including local resources on the user's own computer (e.g., applications, files, etc.) and cloud-based resources (e.g., social networks, virtual files, etc.) In order to allow other user(s) to access computing resource(s) associated with a particular user, the particular user is confronted with various user interfaces that generally involve manual user input (e.g., mouse clicks, button presses, keyboard interactions, etc.)

### SUMMARY

Described herein is a system for granting a privilege, comprising a computer comprising a processor and a memory having computer-executable instructions stored thereupon which, when executed by the processor, cause the computing device to receive information regarding a granting user; determine an identity of the granting user; receive an instruction from the granting user; determine whether or not the received instruction was spoken by the identified granting user; when it is determined that the received instruction was spoken by the identified granting user: provide an authorization code to a device associated with the identified granting user; receive an authorization code; determine whether or not the received authorization code is the same as the authorization code provided to the device associated with the granting user; when it is determined that the received authorization code is the same as the authorization code provided to the device associated with the granting user, grant a privilege to another user based on the received instruction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for granting a privilege.

FIG. 2 is a functional block diagram that illustrates a system for granting a privilege.

FIG. 3 is a functional block diagram that illustrates a system for granting a privilege.

FIG. 4 is a functional block diagram that illustrates a privilege granting service.

FIG. 5 illustrates an exemplary a method of granting a privilege.

FIG. 6 illustrates an exemplary a method of granting a privilege.

FIG. 7 further illustrates the exemplary method of granting a privilege of FIG. 6.

FIG. 8 is a functional block diagram that illustrates an exemplary computing system.

### DETAILED DESCRIPTION

Various technologies pertaining multi-factor privilege granting techniques are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding multi-factor privilege granting techniques. What follows are one or more exemplary systems and methods.

Aspects of the subject disclosure pertain to the technical problem of granting privilege(s) (e.g., to computer-related resource(s)) to other computer user(s). The technical features associated with addressing this problem involve identifying a granting user (e.g., based upon facial recognition technology), confirming the identity of the granting user (e.g., based upon voice recognition technology), determining privilege(s) to be granted by the granting user, using a device associated with the identified granting user, verifying receipt of a code (e.g., randomly generated passcode) and, using voice recognition technology, confirming that the code was audibly read by the granting user. Once the granting user's identity has been confirmed using facial recognition and voice recognition, privilege(s) can be granted to the other user(s). Accordingly, aspects of these technical features exhibit technical effects of more efficiently and effectively granting privilege(s) to other user(s) by the granting user.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “service”, “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

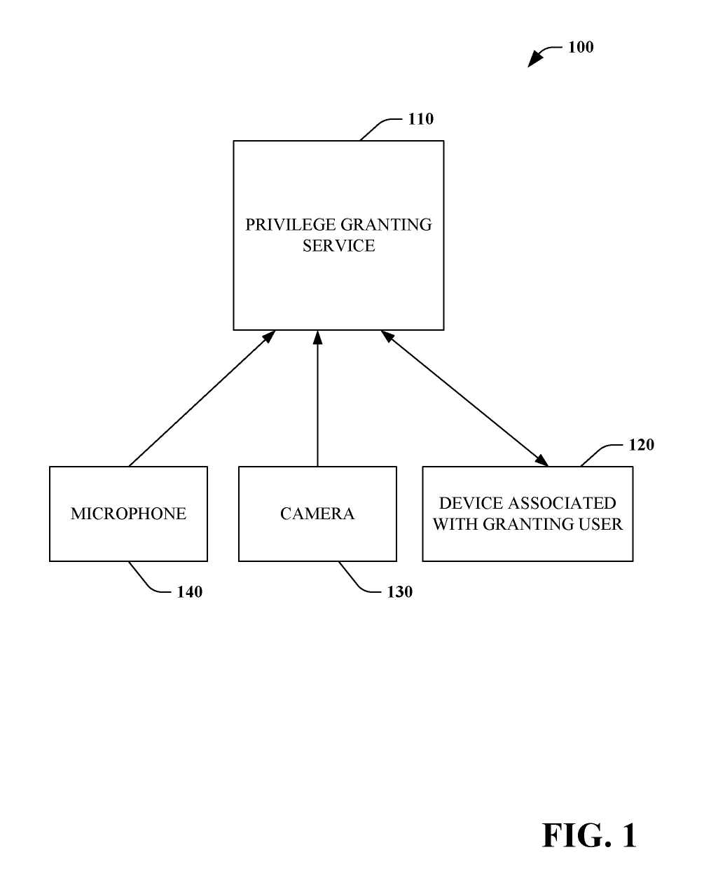

Referring to FIG. 1, a system for granting a privilege 100 is illustrated. The system 100 can utilize a multi-factor technique (e.g., facial recognition and voice recognition) to identify a granting user and determine privilege(s) the granting user desires to grant and/or deny to other user(s). With this multi-factor technique, user frustration related to conventional access-granting procedures, for example, manual user input, can be reduced.

The system 100 includes a privilege granting service 110 that utilizes facial recognition technology and voice recognition technology to identify a granting user. In one embodiment, the privilege granting service 110 further utilizes voice recognition technology to determine privilege(s) the granting user desires to grant to other user(s). In one embodiment, the privilege granting service 110 utilizes voice recognition technology to determine other user(s) to whom the granting user desires to grant privilege(s).

In one embodiment, the privilege granting service 110 is accessible via a network, for example, a cloud-based service accessible via the Internet. In one embodiment, the privilege granting service 110 is a component of one or more devices 120 associated with the granting user. In one embodiment, the privilege granting service 110 is a component of one or more devices associated with other user(s) (not shown).

In one embodiment, the system 100 further includes the one or more devices 120 associated with the granting user. The one or more devices 120 can be any suitable computing device(s) to which a passcode can be provided from the privilege granting service 110. For example, the one or more devices 120 can comprise a mobile phone, a laptop, a tablet and/or a watch.

The system 100 further includes a camera 130 and a microphone 140. In one embodiment, the camera 130 and/or the microphone 140 can be a component of the one or more devices 120 associated with the granting user.

The camera 130 can provide visual information (e.g., image(s)) of a granting user to the privilege granting service 110. The microphone 140 can provide audio information (e.g., voice file(s), stream, etc.) of the granting user to the privilege granting service 110.

In one embodiment, information regarding the granting user is received by the privilege granting service 110. For example, the information can comprise visual information (e.g., image(s)) of the granting user received from the camera 130.

Based upon the information received, the privilege granting service 110 can determine an identity of the granting user, for example, using facial recognition technology. In one embodiment, the identity of the granting user is determined based upon a probability score (e.g., 99% likelihood that the identity is User1).

Next, an instruction to grant privilege(s) to other user(s) is received by the privilege granting service 110. For example, the instruction can comprise audio information received from the microphone 140.

In response, using voice recognition technology, the privilege granting service 110 can determine whether or not the received instruction was spoken by the same person previously identified as the granting user based upon facial recognition technology. The privilege granting service 110 can further determine privilege(s) that the granting user desires to grant to the other user(s).

Once the granting user has been identified using facial recognition technology, the granting user's identity has been confirmed using voice recognition technology and privilege(s) to be granted to other user(s) determined, the privilege granting service 110 can provide an authorization code (e.g., generated passcode) to the one or more device(s) 120 associated with the identified granting user. In one embodiment, the authorization code is valid only for a specific period of time (e.g., two minutes).

In response to receipt of the authorization code on the one or more device(s) 120 associated with the granting user, the granting user provides the authorization code to the privilege granting service 110. In one embodiment, the authorization code is provided by the granting user using the microphone 140.

The privilege granting service 110 can then determine that the correct authorization code and been received. In one embodiment, the privilege granting service 110 can further confirm, using voice recognition technology, that the correct authorization code has been received and spoken by the identified granting user. Thereafter, the other user(s) can be granted the privilege(s) authorized by the granting user.

In one embodiment, an identity of other user(s) which the granting user desires to grant privilege(s) is determined implicitly. For example, when visual information and/or audio information of the granting user is received via a device associated with another particular user, the system 100 can infer that the granting user desires to grant privilege(s) to the another particular user.

In one embodiment, an identity of other user(s) which the granting user desires to grant privilege(s) is determined explicitly. For example, the audio information received by the privilege granting service 110 can explicitly identify another particular user that the granting user desires to grant privilege(s) (e.g., “I want [user identifier] to be able to access my social networking stream”).

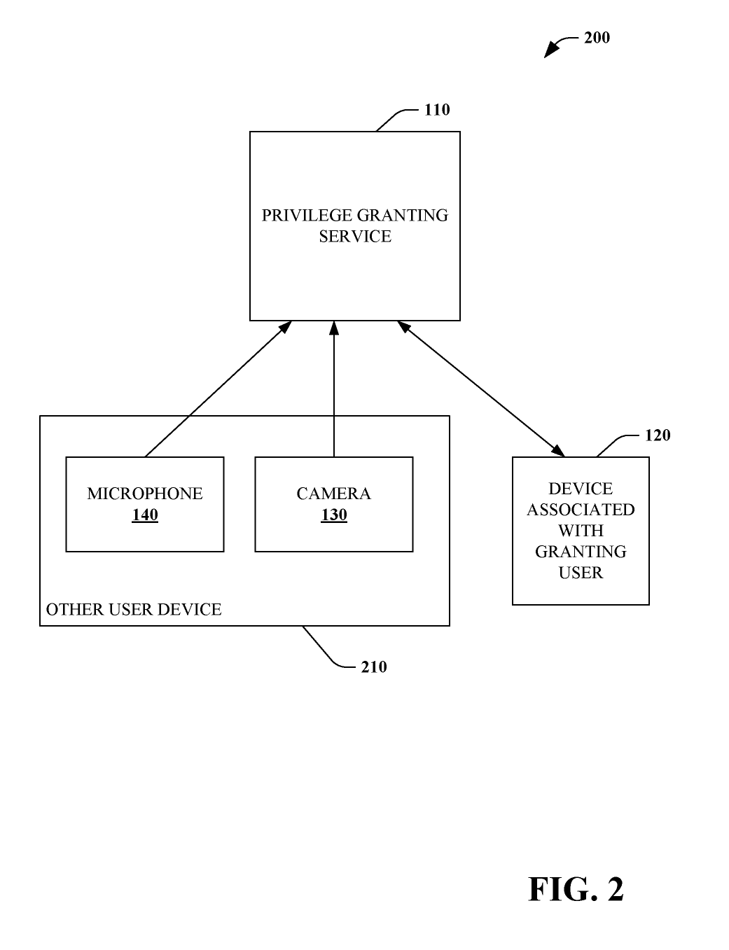

Turning to FIG. 2, the system 100 can include an other user device 210 (e.g., that is not associated with the granting user). In one embodiment, the camera 130 and/or the microphone 140 can be a component of the device 210.

In one embodiment, the device 210 is an augmented reality headset comprising the camera 130 and the microphone 140. For example, a user associated with the device 210 (e.g., augmented reality headset) can initiate the device 210 providing visual information (e.g., image(s)) of a granting user to the privilege granting service 110 (e.g., using the camera 130).

Based upon the provided visual information, the privilege granting service 110 can identify the granting user using facial recognition technology. Thereafter, the user associated with the device 210 can prompt/request the granting user to speak privilege(s) (e.g., instruction(s)) which the granting user desires to grant to the user associated with the device 210 using the microphone 140. At least a portion of the audio spoken by the granting user can be provided to the privilege granting service 110 for analysis.

In one embodiment, the device 210 can provide substantially all of the audio spoken by the granting user to the privilege granting service 110. In one embodiment, the device can provide a textual summary of privilege(s) to be granted and select portion(s) of the audio spoken by the granting user to the privilege granting service 110.

In response to receiving the audio spoken by the granting user, the privilege granting service 110 can determine whether or not the instruction was spoken by the same person identified as the granting user based upon facial recognition technology. The privilege granting service 110 can further determine privilege(s) the granting user desires to grant to the user associated with the device 210.

Once the granting user has been identified using facial recognition technology, the granting user's identity has been confirmed using voice recognition technology and privilege(s) to be granted to the user associated with the device 210 determined, the privilege granting service 110 can provide an authorization code (e.g., generated passcode) to the one or more device(s) 120 associated with the granting user. In one embodiment, the authorization code is valid only for a specific predetermined period of time (e.g., 30 seconds).

In response to receipt of the authorization code on the one or more device(s) 120 associated with the granting user, the granting user provides the authorization code to the privilege granting service 110 using the microphone 140 (e.g., of the device 210 or device 120).

The privilege granting service 110 can then determine that the correct authorization code and been received. In one embodiment, the privilege granting service 110 can further confirm, using voice recognition technology, that the correct authorization code has been received and spoken by the identified granting user. Thereafter, the user of the device 210 can be granted the privilege(s) authorized by the identified granting user.

In one embodiment, system 100 can be utilized to grant privilege(s) to a plurality of other users. For example, the plurality of users can be physically present and/or watching a live stream of a person (e.g., movie actor, singer, etc.), event, etc., with each of the plurality of users having a device 210. Using the camera 130 associated with each device 210, each of the plurality of users can provide an image of the person to the privilege granting system 110.

Thereafter, the person can audibly speak an authorization code which is captured by the microphone 140 of each device 210 and forwarded to the privilege granting service 110. For each of the plurality of devices 210, after confirming that the correct authorization code was forwarded by the particular device, the privilege granting service 110 can grant privilege(s) to a particular user associated with the particular device. In one embodiment, the privilege(s) granted can include access to a movie trailer, video, audio, text file, etc.

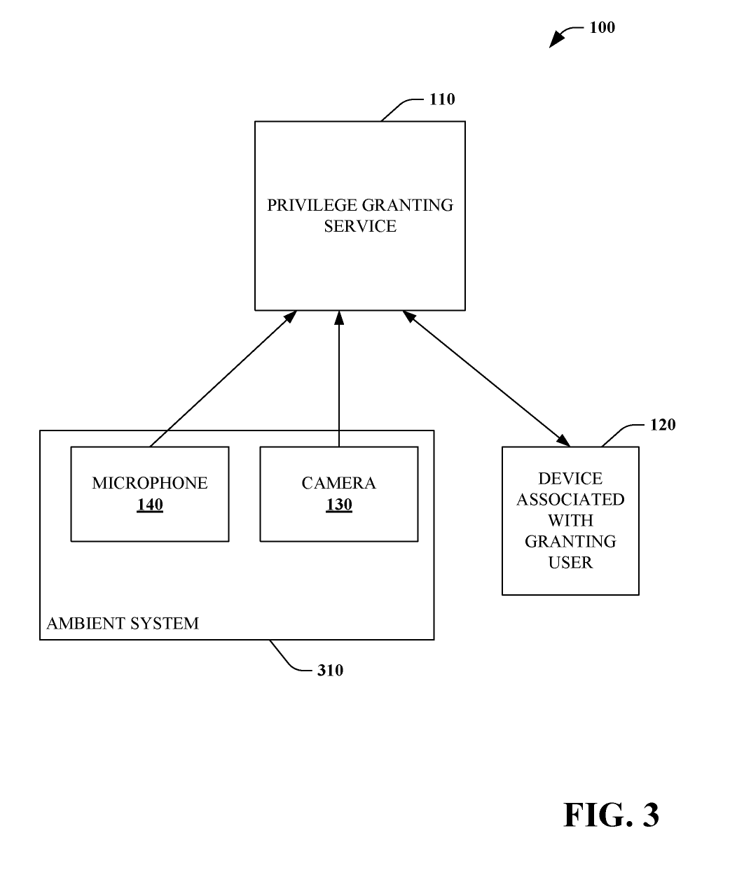

Referring to FIG. 3, in one embodiment, the camera 130 and/or the microphone 140 can be a component of an ambient system 310, for example, a digital assistant system present in an area in which the granting user is also present. With the granting user's consent and in a privacy-preserving manner, the ambient system 310 can provide visual information and/or audio information regarding the granting user and/or other user(s) to the privilege granting service 110.

In one embodiment, neither the granting user nor the other user(s) have actively recording devices. The ambient system 310 can have privileges for the granting user (e.g., granting user has consented to use of the ambient system 310 to communicate with the privilege granting service 110).

The granting user can audibly state the granting user's instruction(s) (e.g., privilege(s) to be granted to other user(s)) which are then transmitted along with visual information regarding the granting user (e.g., image) to the privilege granting service 110 by the ambient system 310. The privilege granting service 110 can identify the granting user using based upon the received visual information using facial recognition technology. Additionally, the privilege granting service can determine whether or not the instruction(s) received were spoken by the same person identified as the granting user based upon facial recognition technology. In one embodiment, the privilege granting service 110 can further identify the other user(s) using facial recognition technology. Finally, the privilege granting service 110 can further determine privilege(s) the granting user desires to grant to the identified other user(s).

Once the granting user has been identified using facial recognition technology, the granting user's identity has been confirmed using voice recognition technology and privilege(s) to be granted to the other user(s) determined, the privilege granting service 110 can provide an authorization code (e.g., generated passcode) to the one or more device(s) 120 associated with the granting user.

In response to receipt of the authorization code on the one or more device(s) 120 associated with the granting user, the granting user provides the authorization code to the privilege granting service 110 using the microphone 140 (e.g., of the ambient system 310).

The privilege granting service 110 can then determine that the correct authorization code and been received. In one embodiment, the privilege granting service 110 can further confirm, using voice recognition technology, that the correct authorization code has been received and spoken by the identified granting user. Thereafter, the identified other user(s) can be granted the privilege(s) authorized by the identified granting user.

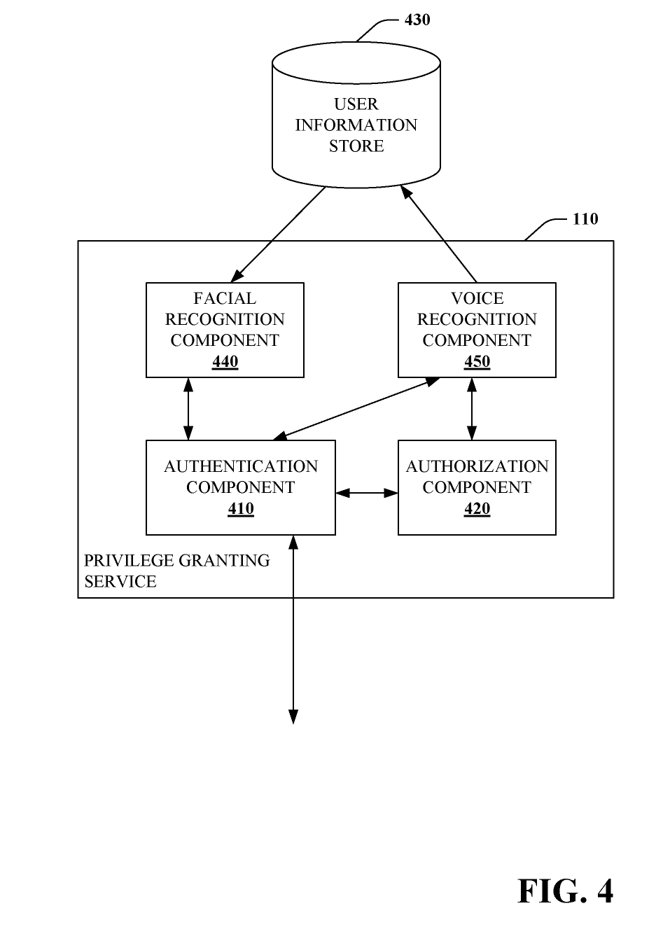

Turning to FIG. 4, a privilege granting service 110 is illustrated. The privilege granting service 110 includes an authentication component 410 and an authorization component 420. The authentication component 410 can determine an identity of a granting user based upon received visual and/or audio information. The authorization component 420 can determine privilege(s) to be granted to other user(s) based upon received instruction(s) (e.g., audio information).

In one embodiment, when a particular user opts-in to utilization of the privilege granting service 110 (e.g., with the particular user's consent) and in a privacy-preserving manner, the particular user can submit an image of the particular user's face, audio information (e.g., voice file of the particular user reading a known text selection) and unique identifiers of one or more device(s) associated with the particular user (e.g., telephone number, computer UUID/GUID, etc.). In this manner, information regarding the particular user's face, voice and associated device(s) can be stored, for example, in a user information store 430, for use by the privilege granting service 110.

The authentication component 410 can utilize a facial recognition component 440 and information stored in the user information store 430 to determine an identity of the granting user based upon received visual information (e.g., image(s) provided by the camera 130. The authentication component 410 can further utilize a voice recognition component 450 and information stored in the user information store 430 to determine whether or not audio information (e.g., instruction(s)) received were spoken by the same person previously identified as the granting user using the facial recognition component 440.

The authentication component 410 can provide an authorization code to one or more device(s) 120 associated with the identified granting user, for example, based upon information stored in the user information store 430. The authentication component 410 can further determine whether or not the correct authorization code was returned. In one embodiment, the authentication component 410 can also utilize the voice recognition component 450 to determine whether or not the authorization code was spoken by the identified granting user.

The authorization component 420 can utilize the voice recognition component 450 to determine privilege(s) the granting user desires to grant to other user(s). Upon identification of the granting user, determination that the identified granting user has spoken the granting instruction(s), receipt of the correct authorization code (and, optionally, confirmed that the correct authorization code was spoken by the identified granting user), the authorization component 420 can grant the privilege(s) to other user(s) as authorized by the granting user.

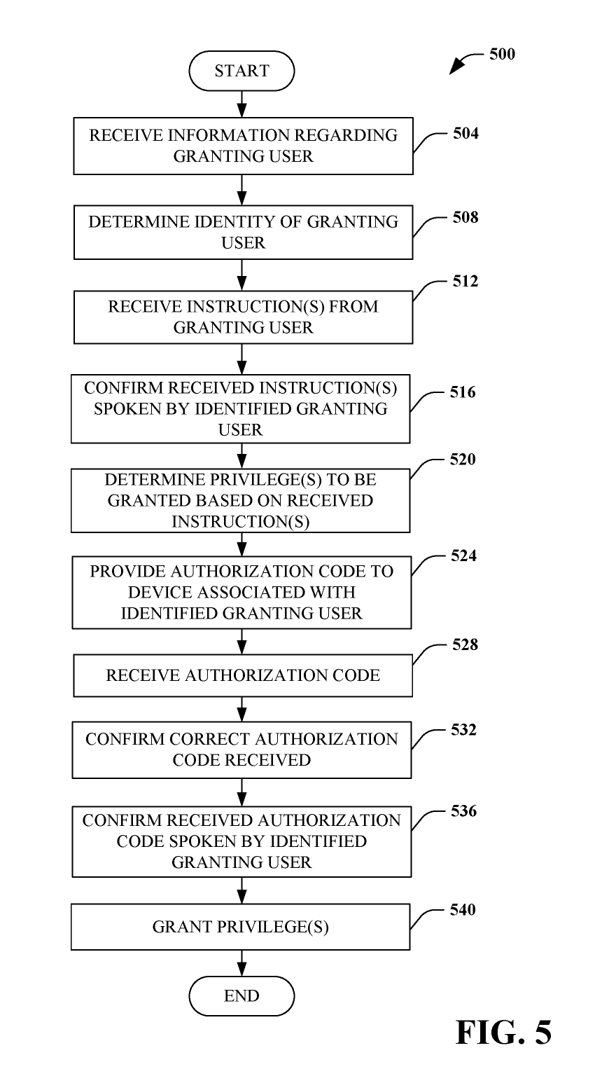

FIGS. 5-7 illustrate exemplary methodologies relating to granting a privilege. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 5, a method of granting a privilege 500 is illustrated. At 504, information regarding a granting user is received. For example, an image of a granting user can be provided by a device associated with the granting user 120 and/or a other user device 210.

At 508, an identity of the granting user is determined, for example, using the facial recognition component 440. At 512, instruction(s) are received from the granting user, for example, using microphone 140.

At 516, the instruction(s) received are confirmed to have been spoken by the identified granting user, for example, using the voice recognition component 450. At 520, privilege(s) to be granted are determined based on the received instruction(s).

At 524, an authorization code is provided to a device associated with the identified granting user. At 528, the authorization code is received from the granting user.

At 532, the authorization code received is confirmed to be the same authorization code provided to the device associated with the granting user. At 536, the authorization code received is confirmed to have been spoken by the identified granting user. At 540, privilege(s) are granted.

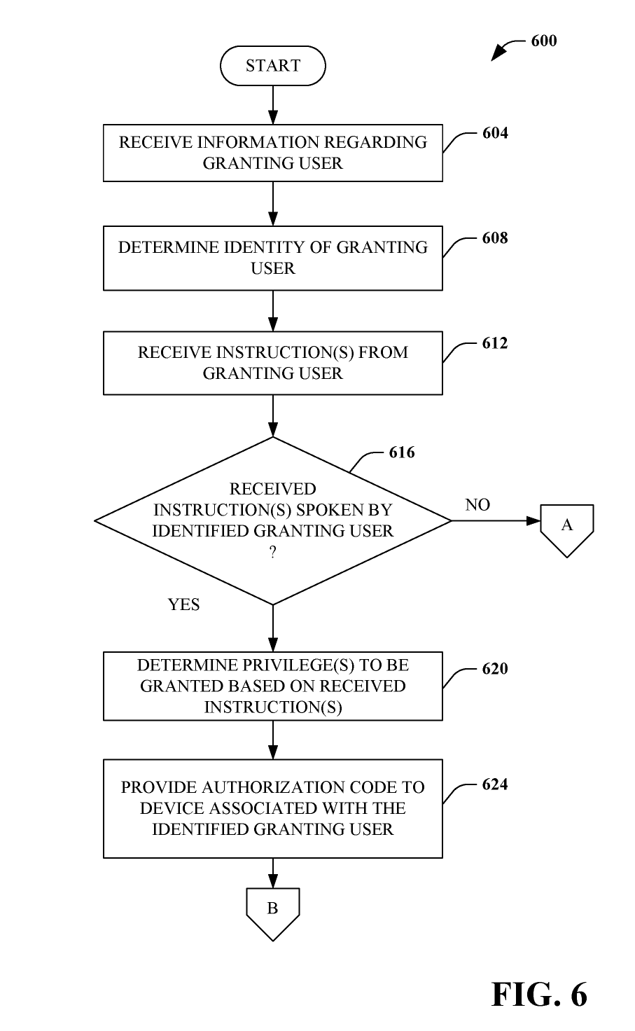

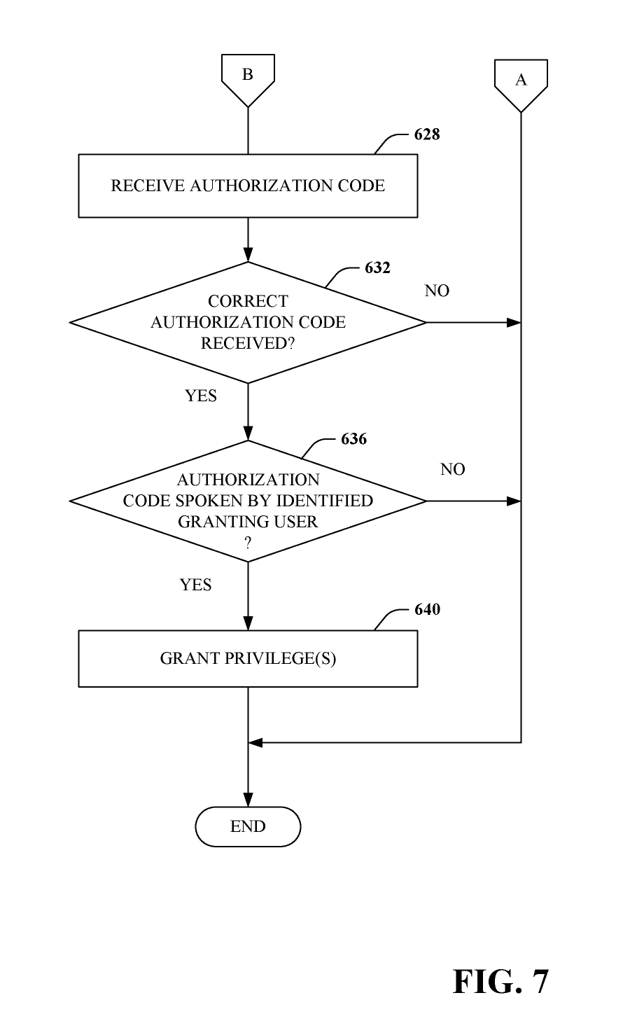

Turning to FIGS. 6 and 7, a method of granting a privilege 600 is illustrated. At 604, information (e.g., image) regarding a granting user is received. At 608, an identity of the granting user is determined using the facial recognition component 440.

At 612, instruction(s) are received from the granting user. At 616, a determination is made as to whether or not the instruction(s) received were spoken by the identified granting user. If the determination at 616 is NO, no further processing occurs. If the determination at 616 is YES, at 620, privilege(s) to be granted are determined based on the received instruction(s).

At 624, an authorization code is provided to a device associated with the identified granting user. At 628, the authorization code is received from the granting user. At 632, a determination is made as to whether the authorization code received from the granting user is correct (e.g., is the same authorization code provided to the device associated with the granting user). If the determination at 632 is NO, no further processing occurs.

If the determination at 632 is YES, at 636, a determination is made as to whether the received authorization was spoken by the identified granting user. If the determination at 636 is NO, no further processing occurs. If the determination at 636 is YES, at 640, privilege(s) are granted based on the received instruction(s).

Described herein is a system for granting a privilege, comprising a computer comprising a processor and a memory having computer-executable instructions stored thereupon which, when executed by the processor, cause the computing device to: receive information regarding a granting user; determine an identity of the granting user; receive an instruction from the granting user; determine whether or not the received instruction was spoken by the identified granting user; when it is determined that the received instruction was spoken by the identified granting user: provide an authorization code to a device associated with the identified granting user; receive an authorization code; determine whether or not the received authorization code is the same as the authorization code provided to the device associated with the granting user; when it is determined that the received authorization code is the same as the authorization code provided to the device associated with the granting user, grant a privilege to another user based on the received instruction.

The system can include wherein the information received regarding the granting user comprises an image of a face of the granting user. The system can further include wherein determine the identity of the granting user comprises utilizing facial recognition. The system can include wherein determine whether or not the received instruction was spoken by the identified granting user comprises utilizing voice recognition.

The system can include wherein the authorization code is valid only for a specific predetermined period of time. The system can further include the memory having further computer-executable instructions stored thereupon which, when executed by the processor, cause the computing device to: determine whether or not the received authorization code was spoken by the identified granting user; only when it is determined that the received authorization code was spoken by the identified granting user, grant the privilege based on the received instruction.

The system can include wherein determine whether or not the received authorization code was spoken by the identified granting user comprises utilizing voice recognition. The system can further include wherein an identity of the another user is determined implicitly based upon a device providing the information regarding the granting user. The system can include wherein an identity of the another is user is determined explicitly based upon audible information provided by the granting user.

Described herein is a method of granting a privilege, comprising: receiving information regarding a granting user; determining an identity of the granting user; receiving an instruction from the granting user; determining whether or not the received instruction was spoken by the identified granting user; when it is determined that the received instruction was spoken by the identified granting user: providing an authorization code to a device associated with the identified granting user; receiving an authorization code; determining whether or not the received authorization code is the same as the authorization code provided to the device associated with the granting user; when it is determined that the received authorization code is the same as the authorization code provided to the device associated with the granting user: determining whether or not the received authorization code was spoken by the identified granting user; when it is determined that the received authorization code was spoken by the identified granting user, granting a privilege to another user based on the received instruction.

The method can include wherein the information received regarding the granting user comprises an image of a face of the granting user. The method can further include wherein determining the identity of the granting user comprises utilizing facial recognition. The method can include wherein determining whether or not the received instruction was spoken by the identified granting user comprises utilizing voice recognition.

The method can include wherein determining whether or not the received authorization code was spoken by the identified granting user comprises utilizing voice recognition. The method can further include wherein an identity of the another user is determined implicitly based upon a device providing the information regarding the granting user. The method can include wherein an identity of the another is user is determined explicitly based upon audible information provided by the granting user.

Described herein is a computer storage media storing computer-readable instructions that when executed cause a computing device to: receive information regarding a granting user; determine an identity of the granting user; receive an instruction from the granting user; determine whether or not the received instruction was spoken by the identified granting user; when it is determined that the received instruction was spoken by the identified granting user: provide an authorization code to a device associated with the identified granting user; receive an authorization code; determine whether or not the received authorization code is the same as the authorization code provided to the device associated with the granting user; when it is determined that the received authorization code is the same as the authorization code provided to the device associated with the granting user: determine whether or not the received authorization code was spoken by the identified granting user; when it is determined that the received authorization code was spoken by the identified granting user, grant a privilege to another user based on the received instruction.

The computer storage media can include wherein the information received regarding the granting user comprises an image of a face of the granting user. The computer storage media can further include wherein determine the identity of the granting user comprises utilizing facial recognition. The computer storage media can include wherein determine whether or not the received instruction was spoken by the identified granting user comprises utilizing voice recognition.

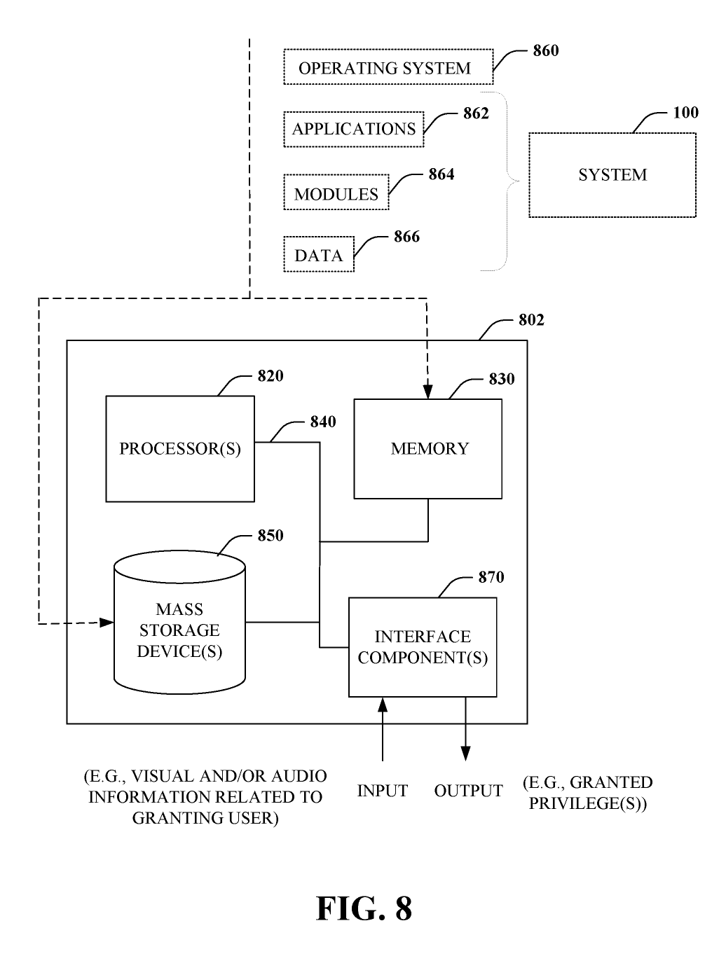

With reference to FIG. 8, illustrated is an example general-purpose computer or computing device 802 (e.g., mobile phone, desktop, laptop, tablet, watch, server, hand-held, programmable consumer or industrial electronics, set-top box, game system, compute node, etc.). For instance, the computing device 802 may be used in a system for granting a privilege 100.

The computer 802 includes one or more processor(s) 820, memory 830, system bus 840, mass storage device(s) 850, and one or more interface components 870. The system bus 840 communicatively couples at least the above system constituents. However, it is to be appreciated that in its simplest form the computer 802 can include one or more processors 820 coupled to memory 830 that execute various computer executable actions, instructions, and or components stored in memory 830. The instructions may be, for instance, instructions for implementing functionality described as being carried out by one or more components discussed above or instructions for implementing one or more of the methods described above.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 820 can be a graphics processor.

The computer 802 can include or otherwise interact with a variety of computer-readable media to facilitate control of the computer 802 to implement one or more aspects of the claimed subject matter. The computer-readable media can be any available media that can be accessed by the computer 802 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 802. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 830 and mass storage device(s) 850 are examples of computer-readable storage media. Depending on the exact configuration and type of computing device, memory 830 may be volatile (e.g., RAM), non-volatile (e.g., ROM, flash memory, etc.) or some combination of the two. By way of example, the basic input/output system (BIOS), including basic routines to transfer information between elements within the computer 802, such as during start-up, can be stored in nonvolatile memory, while volatile memory can act as external cache memory to facilitate processing by the processor(s) 820, among other things.

Mass storage device(s) 850 includes removable/non-removable, volatile/non-volatile computer storage media for storage of large amounts of data relative to the memory 830. For example, mass storage device(s) 850 includes, but is not limited to, one or more devices such as a magnetic or optical disk drive, floppy disk drive, flash memory, solid-state drive, or memory stick.

Memory 830 and mass storage device(s) 850 can include, or have stored therein, operating system 860, one or more applications 862, one or more program modules 864, and data 866. The operating system 860 acts to control and allocate resources of the computer 802. Applications 862 include one or both of system and application software and can exploit management of resources by the operating system 860 through program modules 864 and data 866 stored in memory 830 and/or mass storage device (s) 850 to perform one or more actions. Accordingly, applications 862 can turn a general-purpose computer 802 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 862, and include one or more modules 864 and data 866 stored in memory and/or mass storage device(s) 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 802 also includes one or more interface components 870 that are communicatively coupled to the system bus 840 and facilitate interaction with the computer 802. By way of example, the interface component 870 can be a port (e.g., serial, parallel, PCMCIA, USB, FireWire, etc.) or an interface card (e.g., sound, video, etc.) or the like. In one example implementation, the interface component 870 can be embodied as a user input/output interface to enable a user to enter commands and information into the computer 802, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 870 can be embodied as an output peripheral interface to supply output to displays (e.g., LCD, LED, plasma, etc.), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for granting a privilege, comprising:
a computer comprising a processor and a memory having computer-executable instructions stored thereupon which, when executed by the processor, cause the computing device to:
receive information regarding a granting user;
determine an identity of the granting user;
receive an instruction from the granting user;
determine whether or not the received instruction was spoken by the identified granting user;
when it is determined that the received instruction was spoken by the identified granting user:
provide an authorization code to a device associated with the identified granting user;
receive an authorization code;
determine whether or not the received authorization code is the same as the authorization code provided to the device associated with the granting user;
when it is determined that the received authorization code is the same as the authorization code provided to the device associated with the granting user, grant a privilege to another user based on the received instruction.

2. The system of claim 1, wherein the information received regarding the granting user comprises an image of a face of the granting user.

3. The system of claim 1, wherein determine the identity of the granting user comprises utilizing facial recognition.

4. The system of claim 1, wherein determine whether or not the received instruction was spoken by the identified granting user comprises utilizing voice recognition.

5. The system of claim 1, wherein the authorization code is valid only for a specific predetermined period of time.

6. The system of claim 1, the memory having further computer-executable instructions stored thereupon which, when executed by the processor, cause the computing device to:
determine whether or not the received authorization code was spoken by the identified granting user;
only when it is determined that the received authorization code was spoken by the identified granting user, grant the privilege based on the received instruction.

7. The system of claim 6, wherein determine whether or not the received authorization code was spoken by the identified granting user comprises utilizing voice recognition.

8. The system of claim 1, wherein an identity of the another user is determined implicitly based upon a device providing the information regarding the granting user.

9. The system of claim 1, wherein an identity of the another is user is determined explicitly based upon audible information provided by the granting user.

10. A method of granting a privilege, comprising:
receiving information regarding a granting user;
determining an identity of the granting user;
receiving an instruction from the granting user;
determining whether or not the received instruction was spoken by the identified granting user;
when it is determined that the received instruction was spoken by the identified granting user:
providing an authorization code to a device associated with the identified granting user;
receiving an authorization code;
determining whether or not the received authorization code is the same as the authorization code provided to the device associated with the granting user;
when it is determined that the received authorization code is the same as the authorization code provided to the device associated with the granting user:
determining whether or not the received authorization code was spoken by the identified granting user;
when it is determined that the received authorization code was spoken by the identified granting user, granting a privilege to another user based on the received instruction.

11. The method of claim 10, wherein the information received regarding the granting user comprises an image of a face of the granting user.

12. The method of claim 10, wherein determining the identity of the granting user comprises utilizing facial recognition.

13. The method of claim 10, wherein determining whether or not the received instruction was spoken by the identified granting user comprises utilizing voice recognition.

14. The method of claim 10, wherein determining whether or not the received authorization code was spoken by the identified granting user comprises utilizing voice recognition.

15. The method of claim 10, wherein an identity of the another user is determined implicitly based upon a device providing the information regarding the granting user.

16. The method of claim 10, wherein an identity of the another is user is determined explicitly based upon audible information provided by the granting user.

17. A computer storage media storing computer-readable instructions that when executed cause a computing device to:
receive information regarding a granting user;
determine an identity of the granting user;
receive an instruction from the granting user;
determine whether or not the received instruction was spoken by the identified granting user;
when it is determined that the received instruction was spoken by the identified granting user:
provide an authorization code to a device associated with the identified granting user;
receive an authorization code;
determine whether or not the received authorization code is the same as the authorization code provided to the device associated with the granting user;
when it is determined that the received authorization code is the same as the authorization code provided to the device associated with the granting user:
determine whether or not the received authorization code was spoken by the identified granting user;
when it is determined that the received authorization code was spoken by the identified granting user, grant a privilege to another user based on the received instruction.

18. The computer storage media of claim 17, wherein the information received regarding the granting user comprises an image of a face of the granting user.

19. The computer storage media of claim 17, wherein determine the identity of the granting user comprises utilizing facial recognition.

20. The computer storage media of claim 17, wherein determine whether or not the received instruction was spoken by the identified granting user comprises utilizing voice recognition.
